(19) United States
(12) Patent Application Publication
(10) Pub. No.: US 2024/0420310 A1
(43) Pub. Date: Dec. 19, 2024

(54) AUTOMATIC FLOORBOARD SORTING METHOD

(71) Applicant: Wuxi Hammerhead Shark Intellect Science and Technology Ltd, Wuxi, Jiangsu (CN)

(72) Inventor: Yi Zou, Wuxi, Jiangsu (CN)

(73) Assignee: Wuxi Hammerhead Shark Intellect Science and Technology Ltd, Wuxi, Jiangsu (CN)

(21) Appl. No.: 17/815,739

(22) PCT Filed: Apr. 21, 2022
(86) PCT No.: PCT/CN2022/088043

§ 371 Date: Jul. 29, 2024

(30) Foreign Application Priority Data
Jun. 15, 2021 (CN) 202110661199.2

(51) Int. Cl. G06T 7/00; G06V 10/25; G06V 10/46

(52) U.S. Cl. CPC G06T 7/001; G06V 10/25; G06V 10/462; G06T 2207/20081; G06T 2207/20084; G06T 2207/30161

(57) ABSTRACT

The present disclosure belongs to a sorting method, and specifically relates to an automatic floorboard sorting method. An automatic floorboard sorting method includes the following steps: step 1: a training stage: training an artificial intelligence so that defects of floorboards in a black-and-white image and a color image can be automatically identified by the artificial intelligence; step 2: a using stage: using the artificial intelligence obtained by training in step 1 to perform identification, and performing sampling inspection to continuously iteratively upgrade the artificial intelligence. The present invention has the outstanding effects that an effective identification algorithm is formed by artificial intelligence training, and the algorithm is then used to carry out intelligent identification, so that the identification efficiency is high; the identification effect is good; the marginal cost is low; and it is conductive to the quality control for a floorboard finished product.

### CROSS REFERENCE TO RELATED APPLICATION

This present application claims priority to China Patent Application No. 202110661199.2, filed on Jun. 15, 2021 in China National Intellectual Property Administration and entitled “AUTOMATIC FLOORBOARD SORTING METHOD”, which is hereby incorporated by reference in its entirety.

### TECHNICAL FIELD

The present disclosure relates to the technical field of sorting methods, in particular to an automatic floorboard sorting method.

### BACKGROUND ART

In the wave of Industry 4.0, industrial automation is a development trend. In a flow of industrial automation, intelligent quality inspection is an important part and is a key step to ensure the quality of a product.

In the flooring industry, especially in the field of polyvinyl chloride (PVC) floorboards, the appearance of a floorboard directly affects both the quality of a product and the willingness to buy of consumers. Therefore, almost all manufacturers pay great attention to the quality inspection for the appearance of a floorboard.

In a traditional technology, the quality inspection for the appearance has always been completed through manual visual screening. An experienced worker performs visual identification. However, there are many kinds of appearance defects of a floorboard, such as shown in FIGS. 1-13. These defects include: pits, skewing, broken lines, scratches, bad pieces, dots, holes, bubbles, cross color, impurities, misalignment, coating, and hidden bubbles. During manual identification, with the passage of working time, a worker will inevitably feel fatigue and exhausted in work, and the like, so there may be a floorboard that is not inspected. In addition, different workers have different criteria for the same defect. Some workers think that it is a defect, but some workers think that it is a minor flaw and will not affect subsequent sales and use. Therefore, the criteria are not uniform. At the same time, the labor cost is extremely high, and the manual inspection efficiency is also low.

In conclusion, the traditional inspection method has the following disadvantages: low inspection speed, unstable inspection results, uncontrollable inspection accuracy, high inspection cost, and the like. Therefore, there is a need for an automatic floorboard sorting method.

### SUMMARY

Based on this, the present invention aims to provide an automatic floorboard sorting method. An effective identification algorithm is formed by artificial intelligence training, and the algorithm is then used to carry out intelligent identification, so that the identification efficiency is high; the identification effect is good; the marginal cost is low; and it is conductive to the quality control for a floorboard finished product. In order to achieve the above objective, the present disclosure provides an automatic floorboard sorting method, including the following steps:

step 1: training stage
training an artificial intelligence so that defects of floorboards in a black-and-white image and a color image can be automatically identified by the artificial intelligence;

step 2: using stage
using the artificial intelligence obtained by training in step 1 to perform identification, and performing sampling inspection to continuously iteratively upgrade the artificial intelligence.

According to the above-mentioned automatic floorboard sorting method, the step 1 includes the following content:
step 1.1: preparation of a training set and a verification set;
step 1.2: training;
step 1.3: verification.

According to the above-mentioned automatic floorboard sorting method, the step 1.1 includes the following content:
for first training, each of the training set and the verification set includes a color image and a black-and-white image; the training set includes at least 10000 pieces of color images; each image includes, but only includes, one kind of defect; types and positions of the defects are random; there are a total of 13 kinds of defects including pits, skewing, broken lines, scratches, bad pieces, dots, holes, bubbles, cross color, impurities, misalignment, coating, and hidden bubbles; the number of pictures for each kind of defect is at least 500; the training set includes at least 10000 pieces of black-and-white images; each image includes, but only includes, one kind of defect; types and positions of the defects are random; there are a total of 13 kinds of defects including pits, skewing, broken lines, scratches, bad pieces, dots, holes, bubbles, cross color, impurities, misalignment, coating, and hidden bubbles; the number of pictures for each kind of defect is at least 500;
the pictures in the black-and-white image training set may be black-and-white pictures directly obtained by converting the pictures in the color image training set, or may be black-and-white pictures that are prepared alone;
the verification set includes at least 2000 pieces of color images; each image includes, but only includes, one kind of defect; types and positions of the defects are random; the defects should cover each kind of defect appearing in the training set; the number of pictures for each kind of defect is at least 120; the verification set includes at least 2000 pieces of black-and-white images; each image includes, but only includes, one kind of defect; types and positions of the defects are random; the defects should cover each kind of defect appearing in the training set; the number of pictures for each kind of defect is at least 120;
the pictures in the black-and-white image verification set may be black-and-white pictures directly obtained by converting the pictures in the color image verification set, or may be black-and-white pictures that are prepared alone;
for iterative upgrade training of an artificial intelligence, only the training set and the verification set for the upgrade training are required; the training set includes at least 300 pieces of the color images and 300 pieces of black-and-white images, among which, 200 pieces of defective images and 100 pieces of normal images are included; and the verification set includes at least 120 pieces of color images and 120 pieces of black-and-white images.

According to the above-mentioned automatic floorboard sorting method, the step 1.2 includes the following content:
the training set obtained in the step 1.1 is used to train the artificial intelligence; a CASCADE-RCNN artificial intelligence algorithm or any artificial intelligence algorithm is used for training;
the training is performed on the color images and the black-and-white images, respectively;
the structure of the CASCADE-RCNN artificial intelligence algorithm includes the following three parts:
(1) extracting features: extracting depth features of the images in the training set, where the extraction is performed using a classical resnet50 network, and deformable convolution and a feature pyramid network are added on the basis of the original classical resnet50 network;
(2) determining a region of interest: first generating, according to the extracted depth features and a certain rule, about 20000 anchors on an original drawing, where the rule is that the length-width ratio is [0.2, 0.5, 1.0, 2.0, 5.0] and the area is [8*8, 16*16, 32*32, 64*64, 128*128]; then using the extracted depth features to calculate probabilities that the anchors belong to a foreground, and corresponding position parameters; and selecting 12000 anchors with larger probabilities, and selecting 2000 anchors by non-maximum suppression to obtain a region of interest;
(3) performing cascade classification and regression: inputting the region of interest and the image depth features into a classification and regression module to classify the region of interest and regress the position of the region of interest, where there are 3 levels of cascade; intersection over unions (ious) used by the 3 levels are respectively 0.5, 0.6, and 0.7; an output of the previous level is used as an input of the later level; and as the cascade stage goes on, the inspection performance is gradually improved;
during training, a back propagation algorithm is used to update parameters of a model.

According to the above-mentioned automatic floorboard sorting method, the step 1.2 further includes the following content:
data enhancement measures are used for training, including:
random brightness;
random contrast ratio;
random horizontal flip;
random vertical flip;
random rotation by [−10, 10];
random Gaussian noise disturbance.

According to the above-mentioned automatic floorboard sorting method, the step 1.2 further includes the following content:
a manner for initializing a weight of a first training model is random initialization; after one result is obtained, the initialization is performed using a weight of the previous training result;
the training is performed for a total of 36 rounds, and the learning rate is 0.01; a weight decay is set to be 0.0001; an optimizer adopts Stochastic Gradient Descent (SGD); the learning rate is multiplied by 0.1 respectively at round 27 and round 32; during training, warmup is used to optimize the learning rate, that is, 1/1000 of the default learning rate is used for warmup in the previous 1000 steps, and the default learning rate is then recovered, so that the model can be converged faster;
the size of an image during the training is zoomed according to the proportion of the original drawing, so as to adapt to a memory of a display card; furthermore, a multi-scale training method is used, that is, the size of each input image is different, so as to adapt to flaws in different sizes; each color image is zoomed from pixel 1544 to pixel 2056 according to the longest edge; each black-and-white image is zoomed from pixel 2944 to pixel 3456 according to the longest edge; the specific size is randomly extracted from the range;
in the training process, the representation of the model is tested on a test set every 12 rounds, and model parameters at that time are stored;
during subsequent upgrade training, parameters of Res2 and Res3 modules in a backbone are frozen and are not updated; since the features extracted from the previous several layers are at lower levels and are universally used between different types; and in this way, when a new type is added, only a small data volume can meet the requirements.

According to the above-mentioned automatic floorboard sorting method, the step 1.2 further includes the following content:
the training of the step includes two cases: (1) the color images and the black-and-white images are respectively trained, and two training results are obtained at the time and are then respectively verified; (2) the color images and the black-and-white images are used to train the same artificial intelligence at the same time; at the time, the color images and the black-and-white images need to be trained alternately: the color images and the black-and-white images having the same kind of defect are trained in succession, and the color images and the black-and-white images having different kinds of defects are trained according to a preset order; for the color images and the black-and-white images having the same kind of defect, the color images are trained before the black-and-white images; and after the training, a unique artificial intelligence training result is obtained.

According to the above-mentioned automatic floorboard sorting method, the step 1.3 includes the following content:
the images in the verification set are used to verify a trained deep learning network; if a verification result meets a requirement, subsequent steps are executed; if the verification result does not meet the requirement, the number of color images and the number of black-and-white images in the training set are increased for repeated training;
at least 200 pieces of color images and 200 pieces of black-and-white images are added in the training set at each time, all of which are defective images, and each picture contains and only contains one kind of defect;
if two artificial intelligences are respectively trained in step 1.2, they are verified respectively. If one artificial intelligence is trained, the artificial intelligence is verified using the standard of this step.

According to the above-mentioned automatic floorboard sorting method, the step 2 includes the following content:
step 2.1: identification
the trained model is used to identify a defect of a floorboard, so as to search a defective product from among products;
if a training result of step 1 indicates that two artificial intelligences are trained, the two artificial intelligences are respectively used to identify a defect of a floorboard;
if the training result of step 1 indicates that one artificial intelligence is trained, the artificial intelligence is used to identify a defect of a floorboard;
step 2.2: sampling inspection

Sampling inspection is performed on identification results; both defective products and normal products that are identified should be subjected to sampling injection; the sampling inspection is manually carried out, and may cover at least 10% of the products, that is, 10% of the defective products and 10% of the normal products are subjected to sampling injection; if a sampling injection result of the defective products meets a requirement, and a sampling injection result of the normal products meets a requirement, it indicates that the trained model is executed normally and can be continued to be used; if the sampling injection result of the defective products does not meet the requirement, and the sampling injection result of the normal products meets the requirement, it indicates that the trained model is executed abnormally, so that the entire training set and verification set are re-prepared, and the deep learning algorithm is reset for re-training; if the sampling injection result of the defective products meets the requirement, and the sampling injection result of the normal products does not meet the requirement, defective products among the normal products are collected, a training set and a verification set are manufactured, and upgrade training is performed on the deep learning algorithm; and if the sampling injection result of the defective products does not meet the requirement, and the sampling injection result of the normal products does not meet the requirement, it indicates that the trained model is executed abnormally, so that the entire training set and verification set are re-prepared, and the deep learning algorithm is reset for re-training.

According to the specific embodiments provided by the present disclosure, the present disclosure discloses the following technical effects.

The present invention provides an automatic floorboard sorting method. An effective identification algorithm is formed by artificial intelligence training, and the algorithm is then used to carry out intelligent identification, so that the identification efficiency is high; the identification effect is good; the marginal cost is low; and it is conductive to the quality control for a floorboard finished product. In addition, if there are other defects, the identification algorithm can be upgraded and transformed by supplementary training. It is convenient for upgrade and iteration, and the iteration cost is low.

### BRIEF DESCRIPTION OF THE DRAWINGS

In order to describe the embodiments of the present disclosure or technical solutions in the existing art more clearly, drawings required to be used in the embodiments will be briefly introduced below. Apparently, the drawings in the descriptions below are only some embodiments of the present disclosure. Those ordinarily skilled in the art also can acquire other drawings according to these drawings without creative work.

FIG. 1 is a schematic diagram of a pit defect in an embodiment of the present disclosure;

FIG. 2 is a schematic diagram of a skewing defect in an embodiment of the present disclosure;

FIG. 3 is a schematic diagram of a broken line defect in an embodiment of the present disclosure;

FIG. 4 is a schematic diagram of a scratch defect in an embodiment of the present disclosure;

FIG. 5 is a schematic diagram of a bad piece defect in an embodiment of the present disclosure;

FIG. 6 is a schematic diagram of a dot defect in an embodiment of the present disclosure;

FIG. 7 is a schematic diagram of a hole defect in an embodiment of the present disclosure;

FIG. 8 is a schematic diagram of a bubble defect in an embodiment of the present disclosure;

FIG. 9 is a schematic diagram of a cross color defect in an embodiment of the present disclosure;

FIG. 10 is a schematic diagram of an impurity defect in an embodiment of the present disclosure;

FIG. 11 is a schematic diagram of a misalignment defect in an embodiment of the present disclosure;

FIG. 12 is a schematic diagram of a coating defect in an embodiment of the present disclosure;

FIG. 13 is a schematic diagram of a hidden bubble defect in an embodiment of the present disclosure;

FIG. 14 is a structural diagram of a deep learning model in an embodiment of the present invention.

### DETAILED DESCRIPTION OF THE EMBODIMENTS

The technical solutions in the embodiments of the present disclosure will be described clearly and completely below in combination with the accompanying drawings of the embodiments of the present disclosure. Apparently, the described embodiments are only part of the embodiments of the present disclosure, not all embodiments. Based on the embodiments in the present disclosure, all other embodiments obtained by those of ordinary skill in the art without creative work shall fall within the protection scope of the present disclosure.

Based on this, the present invention aims to provide an automatic floorboard sorting method. An effective identification algorithm is formed by artificial intelligence training, and the algorithm is then used to carry out intelligent identification, so that the identification efficiency is high; the identification effect is good; the marginal cost is low; and it is conductive to the quality control for a floorboard finished product.

In order to make the above-mentioned purposes, characteristics, and advantages of the present disclosure more obvious and understandable, the present disclosure is further described in detail below with reference to the accompanying drawings and specific implementations.

An automatic floorboard sorting method includes the following steps.

### Step 1: Training Stage

### Step 1.1: Preparation of a Training Set and a Verification Set

Each of the training set and the verification set includes a color image and a black-and-white image. The training set includes at least 10000 pieces of color images, and each image includes, but only includes, one kind of defect. Types and positions of the defects are random. There are a total of 13 kinds of defects including pits, skewing, broken lines, scratches, bad pieces, dots, holes, bubbles, cross color, impurities, misalignment, coating, and hidden bubbles, and the number of pictures for each kind of defect is at least 500. The training set includes at least 10000 pieces of black-and-white images. Each image includes, but only includes, one kind of defect. Types and positions of the defects are random. There are a total of 13 kinds of defects including pits, skewing, broken lines, scratches, bad pieces, dots, holes, bubbles, cross color, impurities, misalignment, coating, and hidden bubbles, and the number of pictures for each kind of defect is at least 500.

The pictures in the black-and-white image training set may be black-and-white pictures directly obtained by converting the pictures in the color image training set, or may be black-and-white pictures that are prepared alone.

The verification set includes at least 2000 pieces of color images. Each image includes, but only includes, one kind of defect. Types and positions of the defects are random. The defects should cover each kind of defect appearing in the training set, and the number of pictures for each kind of defect is at least 120. The verification set includes at least 2000 pieces of black-and-white images. Each image includes, but only includes, one kind of defect. Types and positions of the defects are random. The defects should cover each kind of defect appearing in the training set, and the number of pictures for each kind of defect is at least 120.

The pictures in the black-and-white image verification set may be black-and-white pictures directly obtained by converting the pictures in the color image verification set, or may be black-and-white pictures that are prepared alone.

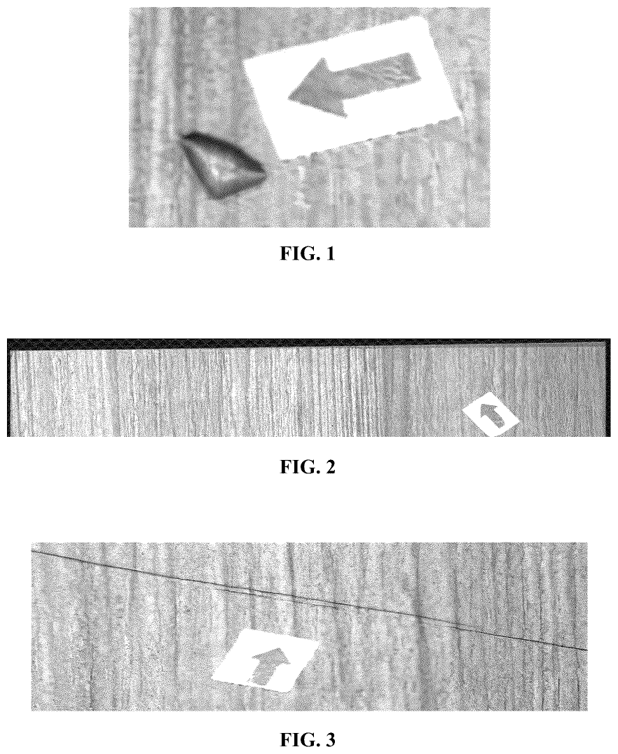

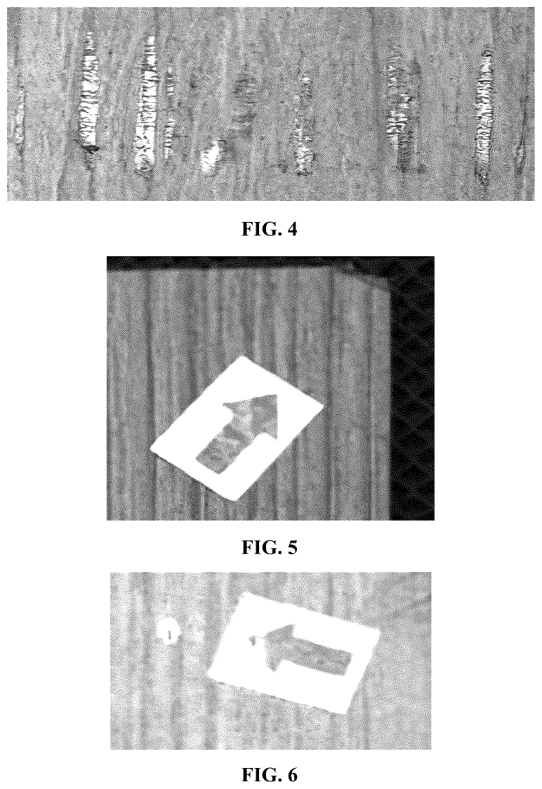

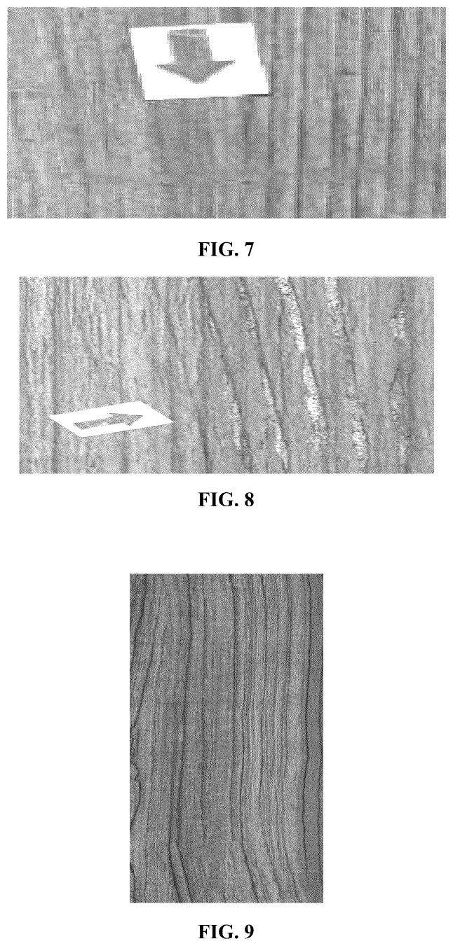

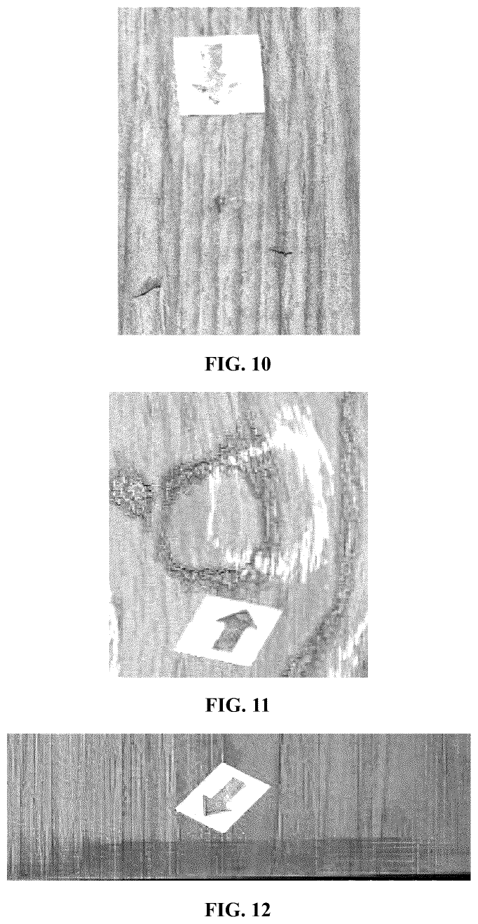

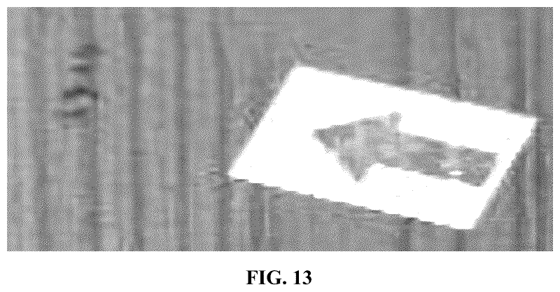

As the patent application requires black-and-white photos or pictures for the attached drawings, the present disclosure does not provide the example of the color image training set. FIGS. 1-13 show the example of the black-and-white image training set.

In addition, the above description aims to first training. For iterative upgrade training of an artificial intelligence, only the training set and the verification set for the upgrade training are required. The training set includes at least 300 pieces of the color images and 300 pieces of black-and-white images, among which, 200 pieces of defective images and 100 pieces of normal images are included; and the verification set includes at least 120 pieces of color images and 120 pieces of black-and-white images.

### Step 1.2: Training

The training set obtained in the step 1.1 is used to train an artificial intelligence; any artificial intelligence algorithm can be used for training, or an artificial intelligence algorithm provided in the present disclosure can also be used for training.

The training is performed on the color images and the black-and-white images, respectively.

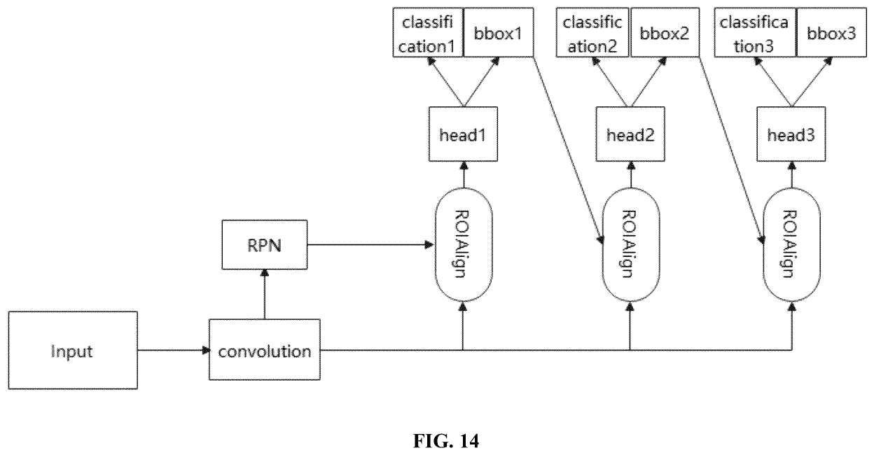

The artificial intelligence algorithm used in the present disclosure is CASCADE-RCNN. The structure of this algorithm is as shown in FIG. 14. In FIG. 14, head1-head3 represent inspection networks 1-3; classification1-classification3 represent classes 1-3; bbox1-bbox3 represents rectangular boxes 1-3; ROIAlign represents bilinear interpolation pooling; RPN represents a region production network; convolution represents convolution; and Input represents an input image.

The structure of the algorithm includes the following three parts:
(1) extracting features: extracting depth features of the images in the training set, where the extraction is performed using a classical resnet50 network, and deformable convolution and a feature pyramid network (FPN) are added on the basis of the original classical resnet50 network;
(2) determining a region of interest: first generating, according to the extracted depth features and a certain rule, about 20000 anchors on an original drawing, where the anchors are actually rectangular boxes with different areas and length-width ratios; a center of each rectangular box overlaps each pixel point of the original drawing; 25 rectangular boxes will be generated on each pixel point; the rule is that the length-width ratio is [0.2, 0.5, 1.0, 2.0, 5.0], and the area is [8*8, 16*16, 32*32, 64*64, 128*128]; then using the extracted depth features to calculate probabilities that the anchors belong to a foreground, and corresponding position parameters; and selecting 12000 anchors with larger probabilities, that is, selecting 12000 anchors with the maximum probabilities, and selecting 2000 anchors by non-maximum suppression (NMS) to obtain a region of interest;
(3) performing cascade classification and regression: inputting the region of interest and the image depth features into a classification and regression module to classify the region of interest and regress the position of the region of interest, where there are 3 levels of cascade; ious used by the 3 levels are respectively 0.5, 0.6, and 0.7; an output of the previous level is used as an input of the later level; and as the cascade stage goes on, the inspection performance is gradually improved.

During training, a back propagation algorithm is used to update parameters of a model.

In addition, data enhancement measures are used for training, including:
random brightness
random contrast ratio
random horizontal flip
random vertical flip
random rotation by [−10, 10]
random Gaussian noise disturbance

A manner for initializing a weight of a first training model is random initialization. After one result is obtained, the initialization is performed using a weight of the previous training result.

The training is performed for a total of 36 rounds, and the learning rate is 0.01; a weight decay is set to be 0.0001; an optimizer adopts SGD; the learning rate is multiplied by 0.1 respectively at round 27 and round 32; during training, warmup is used to optimize the learning rate, that is, 1/1000 of the default learning rate is used for warmup in the previous 1000 steps, and the default learning rate is then recovered, so that the model can be converged faster.

The size of an image during the training is zoomed according to the proportion of the original drawing, so as to adapt to a memory of a display card; furthermore, a multi-scale training method is used, that is, the size of each input image is different, so as to adapt to flaws in different sizes; each color image is zoomed from pixel 1544 to pixel 2056 according to the longest edge; each black-and-white image is zoomed from pixel 2944 to pixel 3456 according to the longest edge; and the specific size is randomly extracted from the range.

In the training process, the representation of the model is tested on a test set every 12 rounds, and model parameters at that time are stored.

During subsequent upgrade training, parameters of Res2 and Res3 modules in a backbone are frozen and are not updated; since the features extracted from the previous several layers are at lower levels and are universally used between different types. In this way, when a new type is added, only a small data volume can meet the requirements.

The training of the step can be performed respectively using the foregoing color images and black-and-white images, and two training results are obtained at this time and are then respectively verified. Or, the color images and the black-and-white images can be used to train the same artificial intelligence at the same time. At this time, the color images and the black-and-white images need to be trained alternately, specifically: the color images and the black-and-white images having the same kind of defect are trained in succession, and the color images and the black-and-white images having different kinds of defects are trained according to a preset order; and for the color images and the black-and-white images having the same kind of defect, the color images are trained before the black-and-white images.

After the training, a unique artificial intelligence training result is obtained.

### Step 1.3: Verification

The images in the verification set are used to verify a trained deep learning network; if a verification result meets a requirement, subsequent steps are executed; and if the verification result does not meet the requirement, the number of color images and the number of black-and-white images in the training set are increased for repeated training.

At least 200 pieces of color images and 200 pieces of black-and-white images are added in the training set at each time, all of which are defective images, and each picture contains and only contains one kind of defect.

If two artificial intelligences are respectively trained in step 1.2, they are verified respectively. If one artificial intelligence is trained, the artificial intelligence is verified using the standard of this step.

### Step 2: Using Stage

### Step 2.1: Identification

The trained model is used to identify a defect of a floorboard, so as to search a defective product from among products.

If a training result of step 1 indicates that two artificial intelligences are trained, the two artificial intelligences are respectively used to identify a defect of a floorboard; if the training result of step 1 indicates that one artificial intelligence is trained, the artificial intelligence is used to identify a defect of a floorboard.

### Step 2.2: Sampling Inspection

Sampling inspection is performed on identification results, and both defective products and normal products that are identified should be subjected to sampling injection. The sampling inspection is manually carried out. The sampling inspection may cover at least 10% of the products, that is, 10% of the defective products and 10% of the normal products are subjected to sampling injection. If a sampling injection result of the defective products meets a requirement, and a sampling injection result of the normal products meets a requirement, it indicates that the identification method of the present disclosure is executed normally and can be continued to be used. If the sampling injection result of the defective products does not meet the requirement, and the sampling injection result of the normal products meets the requirement, it indicates that the identification method of the present disclosure is executed abnormally, so that the entire training set and verification set are re-prepared, and the deep learning algorithm is reset for re-training. If the sampling injection result of the defective products meets the requirement, and the sampling injection result of the normal products does not meet the requirement, defective products among the normal products are collected, a training set and a verification set are manufactured, and upgrade training is performed on the deep learning algorithm. If the sampling injection result of the defective products does not meet the requirement, and the sampling injection result of the normal products does not meet the requirement, it indicates that the identification method of the present disclosure is executed abnormally, so that the entire training set and verification set are re-prepared, and the deep learning algorithm is reset for re-training. The inspection result of the normal products meets the requirement, which means that there is no defective product among the normal products subjected to the sampling inspection. The inspection result of the defective products meets the requirement, which means that there is no normal product among the defective products subjected to the sampling inspection.

All the embodiments in the specification are described in a progressive manner. Contents mainly described in each embodiment are different from those described in other embodiments. Same or similar parts of all the embodiments refer to each other.

The principle and implementation modes of the present disclosure are described by applying specific examples herein. The descriptions of the above embodiments are only intended to help to understand the method of the present disclosure and a core idea of the method. In addition, those ordinarily skilled in the art can make changes to the specific implementation modes and the application scope according to the idea of the present disclosure. From the above, the contents of this specification shall not be deemed as limitations to the present disclosure.

What is claimed is:

1. An automatic floorboard sorting method, comprising the following steps:
step 1: training stage
training an artificial intelligence so that defects of floorboards in a black-and-white image and a color image can be automatically identified by the artificial intelligence;
step 2: using stage
using the artificial intelligence obtained by training in step 1 to perform identification, and performing sampling inspection to continuously iteratively upgrade the artificial intelligence.

2. The automatic floorboard sorting method according to claim 1, wherein the step 1 comprises the following content:
step 1.1: preparation of a training set and a verification set;
step 1.2: training;
step 1.3: verification.

3. The automatic floorboard sorting method according to claim 2, wherein the step 1.1 comprises the following content:
for first training, each of the training set and the verification set comprises a color image and a black-and-white image; the training set comprises at least 10000 pieces of color images; each image comprises, but only comprises, one kind of defect; types and positions of the defects are random; there are a total of 13 kinds of defects comprising pits, skewing, broken lines, scratches, bad pieces, dots, holes, bubbles, cross color, impurities, misalignment, coating, and hidden bubbles; the number of pictures for each kind of defect is at least 500; the training set comprises at least 10000 pieces of black-and-white images; each image comprises, but only comprises, one kind of defect; types and positions of the defects are random; there are a total of 13 kinds of defects comprising pits, skewing, broken lines, scratches, bad pieces, dots, holes, bubbles, cross color, impurities, misalignment, coating, and hidden bubbles; the number of pictures for each kind of defect is at least 500;
the pictures in the black-and-white image training set may be black-and-white pictures directly obtained by converting the pictures in the color image training set, or may be black-and-white pictures that are prepared alone;
the verification set comprises at least 2000 pieces of color images; each image comprises, but only comprises, one kind of defect; types and positions of the defects are random; the defects should cover each kind of defect appearing in the training set; the number of pictures for each kind of defect is at least 120; the verification set comprises at least 2000 pieces of black-and-white images; each image comprises, but only comprises, one kind of defect; types and positions of the defects are random; the defects should cover each kind of defect appearing in the training set; the number of pictures for each kind of defect is at least 120;
the pictures in the black-and-white image verification set may be black-and-white pictures directly obtained by converting the pictures in the color image verification set, or may be black-and-white pictures that are prepared alone;
for iterative upgrade training of an artificial intelligence, only the training set and the verification set for the upgrade training are required; the training set comprises at least 300 pieces of the color images and 300 pieces of black-and-white images, among which, 200 pieces of defective images and 100 pieces of normal images are comprised; and the verification set comprises at least 120 pieces of color images and 120 pieces of black-and-white images.

4. The automatic floorboard sorting method according to claim 3, wherein the step 1.2 comprises the following content:
the training set obtained in the step 1.1 is used to train the artificial intelligence; a CASCADE-RCNN artificial intelligence algorithm or any artificial intelligence algorithm is used for training;
the training is performed on the color images and the black-and-white images, respectively;
the structure of the CASCADE-RCNN artificial intelligence algorithm comprises the following three parts:
(1) extracting features: extracting depth features of the images in the training set, where the extraction is performed using a classical resnet50 network, and deformable convolution and a feature pyramid network are added on the basis of the original classical resnet50 network;
(2) determining a region of interest: first generating, according to the extracted depth features and a certain rule, about 20000 anchors on an original drawing, where the rule is that the length-width ratio is [0.2, 0.5, 1.0, 2.0, 5.0] and the area is [8*8, 16*16, 32*32, 64*64, 128*128]; then using the extracted depth features to calculate probabilities that the anchors belong to a foreground, and corresponding position parameters; and selecting 12000 anchors with larger probabilities, and selecting 2000 anchors by non-maximum suppression to obtain a region of interest;
(3) performing cascade classification and regression: inputting the region of interest and the image depth features into a classification and regression module to classify the region of interest and regress the position of the region of interest, where there are 3 levels of cascade; intersection over unions (ious) used by the 3 levels are respectively 0.5, 0.6, and 0.7; an output of the previous level is used as an input of the later level; and as the cascade stage goes on, the inspection performance is gradually improved;
during training, a back propagation algorithm is used to update parameters of a model.

5. The automatic floorboard sorting method according to claim 4, wherein the step 1.2 further comprises the following content:
data enhancement measures are used for training, comprising:
random brightness;
random contrast ratio;
random horizontal flip;
random vertical flip;
random rotation by [−10, 10];
random Gaussian noise disturbance.

6. The automatic floorboard sorting method according to claim 5, wherein the step 1.2 further comprises the following content:
a manner for initializing a weight of a first training model is random initialization; after one result is obtained, the initialization is performed using a weight of the previous training result;
the training is performed for a total of 36 rounds, and the learning rate is 0.01; a weight decay is set to be 0.0001; an optimizer adopts Stochastic Gradient Descent (SGD); the learning rate is multiplied by 0.1 respectively at round 27 and round 32; during training, warmup is used to optimize the learning rate, that is, 1/1000 of the default learning rate is used for warmup in the previous 1000 steps, and the default learning rate is then recovered, so that the model can be converged faster;
the size of an image during the training is zoomed according to the proportion of the original drawing, so as to adapt to a memory of a display card; furthermore, a multi-scale training method is used, that is, the size of each input image is different, so as to adapt to flaws in different sizes; each color image is zoomed from pixel 1544 to pixel 2056 according to the longest edge; each black-and-white image is zoomed from pixel 2944 to pixel 3456 according to the longest edge; the specific size is randomly extracted from the range;
in the training process, the representation of the model is tested on a test set every 12 rounds, and model parameters at that time are stored;
during subsequent upgrade training, parameters of Res2 and Res3 modules in a backbone are frozen and are not updated; since the features extracted from the previous several layers are at lower levels and are universally used between different types; and in this way, when a new type is added, only a small data volume can meet the requirements.

7. The automatic floorboard sorting method according to claim 6, wherein the step 1.2 further comprises the following content:
the training of the step comprises two cases: (1) the color images and the black-and-white images are respectively trained, and two training results are obtained at the time and are then respectively verified; (2) the color images and the black-and-white images are used to train the same artificial intelligence at the same time; at the time, the color images and the black-and-white images need to be trained alternately: the color images and the black-and-white images having the same kind of defect are trained in succession, and the color images and the black-and-white images having different kinds of defects are trained according to a preset order; for the color images and the black-and-white images having the same kind of defect, the color images are trained before the black-and-white images; and after the training, a unique artificial intelligence training result is obtained.

8. The automatic floorboard sorting method according to claim 7, wherein the step 1.3 comprises the following content:
the images in the verification set are used to verify a trained deep learning network; if a verification result meets a requirement, subsequent steps are executed; if the verification result does not meet the requirement, the number of color images and the number of black-and-white images in the training set are increased for repeated training;
at least 200 pieces of color images and 200 pieces of black-and-white images are added in the training set at each time, all of which are defective images, and each picture contains and only contains one kind of defect;
if two artificial intelligences are respectively trained in step 1.2, they are verified respectively; and if one artificial intelligence is trained, the artificial intelligence is verified using the standard of this step.

9. The automatic floorboard sorting method according to claim 8, wherein the step 2 comprises the following content:
step 2.1: identification
the trained model is used to identify a defect of a floorboard, so as to search a defective product from among products;
if a training result of step 1 indicates that two artificial intelligences are trained, the two artificial intelligences are respectively used to identify a defect of a floorboard; if the training result of step 1 indicates that one artificial intelligence is trained, the artificial intelligence is used to identify a defect of a floorboard;
step 2.2: sampling inspection
sampling inspection is performed on identification results; both defective products and normal products that are identified should be subjected to sampling injection; the sampling inspection is manually carried out, and may cover at least 10% of the products, that is, 10% of the defective products and 10% of the normal products are subjected to sampling injection; if a sampling injection result of the defective products meets a requirement, and a sampling injection result of the normal products meets a requirement, it indicates that the trained model is executed normally and can be continued to be used; if the sampling injection result of the defective products does not meet the requirement, and the sampling injection result of the normal products meets the requirement, it indicates that the trained model is executed abnormally, so that the entire training set and verification set are re-prepared, and the deep learning algorithm is reset for re-training; if the sampling injection result of the defective products meets the requirement, and the sampling injection result of the normal products does not meet the requirement, defective products among the normal products are collected, a training set and a verification set are manufactured, and upgrade training is performed on the deep learning algorithm; and if the sampling injection result of the defective products does not meet the requirement, and the sampling injection result of the normal products does not meet the requirement, it indicates that the trained model is executed abnormally, so that the entire training set and verification set are re-prepared, and the deep learning algorithm is reset for re-training.
